(19) United States
(12) Patent Application Publication
(10) Pub. No.: US 2021/0135541 A1
(43) Pub. Date: May 6, 2021

(54) Permanent magnet motor

(71) Applicant: David H. Beason, Braselton, GA (US)

(72) Inventor: David H. Beason, Braselton, GA (US)

(21) Appl. No.: 16/670,553

(22) Filed: Oct. 31, 2019

(51) Int. Cl. H02K 7/00; H02K 21/14; H02K 11/00

(52) U.S. Cl. CPC H02K 7/006; B60K 6/26; H02K 11/0094; H02K 21/14

(57) ABSTRACT

A rotating magnet electrical motor. The apparatus may be used with an electric vehicle as a supplemental power source. The device uses an energy storage component to provide initial start up power and may then run until the storage component is completely de-energized. The energy storage device, which may be a capacitor, provides energy pulses which are applied to a series of energizing coils which are positioned to apply an electromagnetic field to a magnet to produce rotating motion. The pulses are applied to the coils in accordance with a predetermined timing pattern. The energy storage component can be conveniently recharged when recharging the vehicle battery.

### FIELD OF THE INVENTION

The present invention relates to power generation. More particularly, the invention discloses a device that generates electricity from a rotating magnet assembly.

### BACKGROUND OF THE INVENTION

Power generating devices using rotating magnet assemblies are well known in the art. Both generators and alternators run on the basic principle of producing electricity from an AC magnetic field. Electric motors run on the basic principle of producing motive power from an AC magnetic field.

Electric vehicles are inherently inefficient however, accordingly, methods of increasing the efficiency of these machines are numerous. The most commonly used method is regenerative braking. This method uses the braking process to generate electrical power, essentially using the basic principles discussed above. While this method can be used to increase efficiency by about 25%, it has drawbacks such as high cost of implementation and a relatively sophisticated mechanism.

Typical of these is the system disclosed in U.S. Pat. No. 8,818,669. It mainly comprises a computer 2, a control device 3, a means 4 of determining the speed of the vehicle (longitudinal speed), an energy regeneration braking device 5 and, if necessary, a means of detecting an action on a control member of a dissipative braking device. The means of detecting an action on a control member of a dissipative braking device may, for example, comprise a contact detector on the control member of the dissipative braking device. Alternatively, the detection device may comprise a force sensor sensing the force applied to the control member of the dissipative braking device, an action being considered to be exerted on the member when the force value supplied by the sensor exceeds a force threshold. Alternatively again, the detection means may comprise a position sensor sensing the position of the control member of the dissipative braking device, an action being considered to be exerted on the member when the position value supplied by the sensor exceeds a position threshold. The detection means generates an action signal on the dissipative braking control member which is transmitted to the computer, the signal comprising information indicating presence or absence of action on the dissipative braking control member.

As can be gleaned from the above discussion, these systems are complex because of the need to control the braking system for safe operation of the vehicle, while also managing power generation and distribution. In other words, these systems demand active, i.e., computer control in order to reach peak effectiveness.

In light of the range problem with electric vehicles, some vehicles are electric/gas hybrids. These vehicles use a small gas powered engine to provide supplemental power. Thus the vehicles have to have a fuel system which includes a gas tank all of which adds weight to the vehicle. And of course the vehicle also emits greenhouse gases.

The present invention is directed to a rotating magnet electrical motor. The apparatus may be used with an electric vehicle as a supplemental power source. The device uses an energy storage component to provide initial start up power and may then run until the storage component is completely de-energized. The energy storage device, which may be a capacitor, provides energy pulses which are applied to a series of energizing coils which are positioned to apply an electromagnetic field to a magnet to produce rotating motion. The pulses are applied to the coils in accordance with a predetermined timing pattern. The energy storage component can be conveniently recharged when recharging the vehicle battery.

### SUMMARY OF THE INVENTION

It is a major object of the invention to provide an electrical motor.

It is another object of the invention to provide an electrical motor apparatus that can be used as supplemental power in an electric vehicle.

It is another object of the invention to provide an electrical motor apparatus that uses a switched passive energy source to effect startup and continuous rotation.

It is another object of the invention to provide an electrical motor apparatus that uses energizing pulses from the passive energy source to motivate a permanent magnet rotor.

### BRIEF DESCRIPTION OF THE DRAWINGS

FIG. 1 shows a representative vehicle with which the invention may be practiced.

FIG. 2 shows a diagrammatic representation of the components of the generator arrangement of the invention.

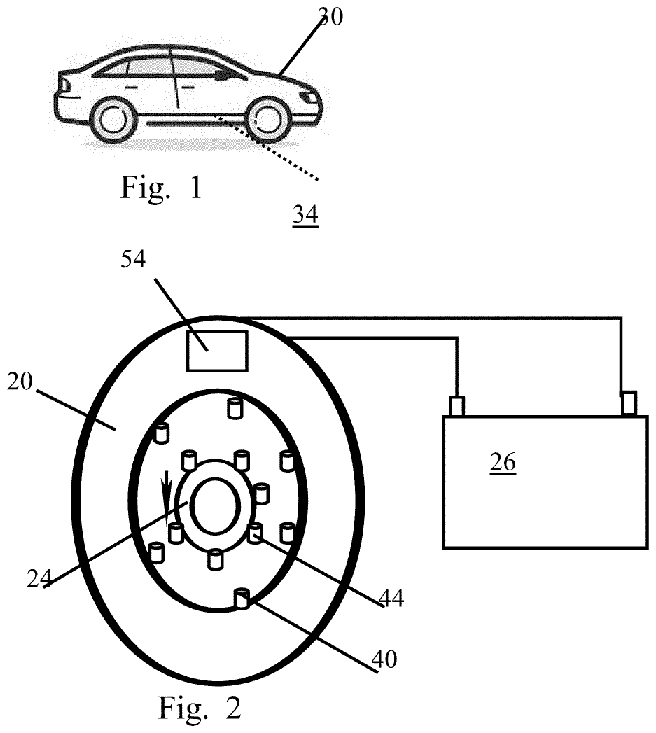

### DETAILED DESCRIPTION

The present invention is directed to an electrical motor apparatus for use as a source of main or supplemental power. The motor has particular use as a source of supplemental power in an automobile, taking the place of the standard small gas powered engine. The motor apparatus, generally indicated by the numeral 10, is designed to run from an energy storage device which can apply pulses in accordance with a predetermined timing pattern to ensure the efficient operation of the motor.

The apparatus 10, diagrammatically illustrated in FIG. 2 includes 4 main components. A stationary bracket 20, a rotor 24, one or more capacitors 26, and a control module.

The bracket 20 is a hollow metal partial enclosure which is attached within the vehicle 30 engine bay 32. The bracket 20 is firmly secured in non-rotating manner within the vehicle 30 using standard engine mounting techniques as would be apparent to one of skill in the art, these techniques being necessary due to the high amount of torque and the need to transfer power smoothly to the drive shaft 34 of the vehicle. A series of circumferentially spaced electromagnets 40 are rigidly attached to the inner surface of the bracket 20. These electromagnets 40, which are basically coils, supply an AC magnetic field which can be used to drive the rotor 24.

Rotor 24 has a series of circumferentially spaced permanent magnets 44 positioned about one end. The other end of the rotor 24 is connected, via a mechanical linkage, to the crankshaft 46 of the vehicle 30 in the same manner as the gasoline engine in a hybrid vehicle. Rotor 24 rotates freely within bracket 20, with rotation effected by presenting an AC magnetic field to the permanent magnets 44 as will be discussed in more detail later.

In order to initiate rotation of the rotor 24, the coils 40 have to be energized. Energization of the coils 40 must be done in accordance with a predetermined timing pattern, which pattern is a function of the spacing of coils 40 and magnets 44, as well as the speed of rotation of the rotor 24 as will be explained in more detail below. Energizing the coils 40 is preferably done by switchably connecting capacitors 50 to the coils 40. The capacitors 50, which are high energy storage capacitors such as supercapacitors, provide the electrical energy needed to energize coils 40. In a preferred embodiment, the capacitors 50 are charged when the main batteries of the vehicle 30 are charged. Thus the capacitors 50 essentially function as a reserve “tank” by adding to the overall energy storage capacity of the vehicle 30.

As previously stated, the coils 40 must be pulsed in a predetermined sequence in order to motivate the rotor 24 in the most energy efficient manner possible. To that end, a control module 54 is provided. The module 54, which may be a standard programmable microprocessor, supplies electrical power to the coils 40 in a predetermined timing pattern. This pattern would be based upon the spacing of the coils 40 and the speed of rotation of the rotor 24 and magnets 44. The timing required would be apparent to one of skill in the art and does not form a part of the invention. The capacitors 50 would be charged at the same time as the vehicle 30 is charged, and in a preferred embodiment, capacitors 50 should be sufficient to last as long as the overall vehicle 30 charge. This could be done in a number of ways such as using energy from the regenerative braking system to charge capacitors 50 and not the vehicle battery.

I claim:

1. A supplemental source of motive power for an electric vehicle comprising
a stationary bracket mounted within said vehicle and affixed therein in a non-rotational manner, said bracket having a series of circumferentially spaced electromagnets positioned on an interior surface;
a rotor positioned within said bracket and supported for rotation within the bracket, the rotor having a series of circumferentially spaced permanent magnets thereon;
a passive energy source connectable to said electromagnets for providing electrical power thereto;
whereby said rotor can provide motive power to said vehicle by sequentially pulsing said electromagnets with energy from said energy source.
